(19) United States
(12) Patent Application Publication
(10) Pub. No.: US 2024/0142849 A1
(43) Pub. Date: May 2, 2024

(54) PHOTONIC ASSEMBLY

(71) Applicant: Kabushiki Kaisha Toshiba, Tokyo (JP)

(72) Inventors: Taofiq PARAISO, Cambridge (GB); Andrew James SHIELDS, Cambridge (GB)

(73) Assignee: Kabushiki Kaisha Toshiba, Tokyo (JP)

(21) Appl. No.: 18/457,819

(22) Filed: Aug. 29, 2023

(30) Foreign Application Priority Data
Oct. 31, 2022 (GB) 2216159.0

(51) Int. Cl. G02F 1/225; G02F 1/01; G02F 1/21; H04L 9/08

(52) U.S. Cl. CPC G02F 1/2257; G02F 1/0144; G02F 1/212; H04L 9/0858

(57) ABSTRACT

A photonic assembly comprising: a first section, the first section comprising a first substrate; and a second section, the second section comprising a second substrate; wherein the photonic assembly comprises an interferometer, the interferometer comprising a plurality of passive photonic elements and a phase modulator; wherein the phase modulator is provided on the second section; and wherein the plurality of passive photonic elements are provided on the first section.

### FIELD

Embodiments described herein relate to a photonic assembly.

### BACKGROUND

Quantum key distribution (QKD) is a technique which results in the sharing of cryptographic keys between two parties: a transmitter often referred to as “Alice”; and a receiver often referred to as “Bob”. The attraction of this technique is that it provides a test of whether any part of the key can be known to an unauthorised eavesdropper, often referred to as “Eve”. In many forms of quantum key distribution, Alice and Bob use two or more non-orthogonal bases in which to encode the bit values. The laws of quantum mechanics dictate that measurement of the photons by Eve without prior knowledge of the encoding basis of each causes an unavoidable change to the state of some of the photons. These changes to the states of the photons will cause errors in the bit values sent between Alice and Bob. By comparing a part of their common bit string, Alice and Bob can thus determine if Eve has gained information.

QKD schemes are implemented in a quantum communication system, where information is sent between a transmitter and a receiver by encoded single quanta, such as single photons. Transmitters and receivers in quantum communication systems utilise interferometers to implement encoding and decoding of quantum states.

### BRIEF DESCRIPTION OF THE DRAWINGS

Embodiments will now be described by way of example with reference to the accompanying drawings.

FIG. 1 is a schematic of an encoding photonic assembly in accordance with one embodiment.

FIG. 2 is a schematic of an encoding photonic assembly in accordance with one embodiment.

FIG. 3 is a schematic of a decoding photonic assembly in accordance with one embodiment.

FIG. 4 is a schematic of an encoding or decoding photonic assembly in accordance with one embodiment.

FIG. 5 is a schematic of an encoding or decoding photonic assembly in accordance with one embodiment.

FIG. 6 is a schematic of an encoding photonic assembly in accordance with one embodiment.

FIG. 7 is a schematic of an encoding photonic assembly in accordance with one embodiment.

FIG. 8 is a schematic of a decoding photonic assembly in accordance with one embodiment.

FIG. 9 is a schematic of a decoding photonic assembly in accordance with one embodiment.

FIG. 10 is a schematic of an intensity modulator photonic assembly in accordance with one embodiment.

FIG. 11 is a schematic of an intensity modulator photonic assembly in accordance with one embodiment.

FIG. 12 is a schematic of a photonic assembly including a Sagnac interferometer in accordance with one embodiment.

FIG. 13 is a schematic of a photonic assembly comprising polarizing elements in accordance with one embodiment.

FIG. 14 is a schematic of a photonic assembly comprising reflector elements in accordance with one embodiment.

FIG. 15A shows schematics of different phase modulator arrangements, in accordance with embodiments described herein.

FIG. 15B illustrates a Mach-Zehnder Interferometer.

FIGS. 16A-16F illustrate schematics of photonic assemblies having optical input and optical output arrangements in accordance with embodiments described herein.

FIG. 17 is a schematic of a quantum communication system in accordance with an embodiment.

### DETAILED DESCRIPTION

In an embodiment, a photonic assembly is provided, comprising:
a first section, the first section comprising a first substrate; and
a second section, the second section comprising a second substrate;
wherein the photonic assembly comprises an interferometer, the interferometer comprising a plurality of passive photonic elements and a phase modulator;
wherein the phase modulator is provided on the second section; and
wherein the plurality of passive photonic elements are provided on the first section.

The photonic assembly provides a photonic integrated circuit having an interferometer that minimises losses while operating active photonic components at high switching speeds. The photonic assembly is a hybrid photonic assembly and comprises a first section comprising at least one first photonic component and a second section comprising at least one second photonic components. The at least one first photonic component includes passive photonic circuit elements, such as waveguides, couplers and delay lines, and are formed on the first section. The at least one second set of photonic components includes a fast phase modulator, and is formed on the second section.

Passive photonic elements and the phase modulator are manufactured through different fabrication processes, with different machining and tools. The passive photonic elements and the phase modulator may also be formed using different materials. By providing the passive elements and the fast phase modulator on different sections of the photonic assembly, each section can be manufactured separately. This provides a more efficient and quicker manufacturing process.

In addition, the manufacture and structure of each section of the photonic assembly can be independently optimised. The fabrication of the first section and the passive photonic elements on the first section can be optimised to minimise propagation losses through the passive photonic circuit elements. Separately, the fabrication of the second section and the phase modulator on the section can be optimised to enable the phase modulator to operate with fast response times and can switch modulation configuration at a higher speed (e.g. GHz or faster).

The interferometer on the photonic assembly assembled from independently optimised sections therefore operates with lower propagation loss as compared to an interferometer with all interferometer elements on a single section optimised for higher modulator switching speeds. The assembled photonic assembly is also able to perform at higher switching speeds than an interferometer formed with all interferometer elements on a single section optimised for low propagation loss.

In one embodiment, the phase modulator is an electro-optic phase modulator.

In one embodiment, the plurality of passive photonic components comprises one or more waveguides.

In one embodiment, the interferometer further comprises one or more additional waveguides provided on the second section, wherein at least one of the one or more waveguides is coupled to at least one of the one or more additional waveguides.

In one embodiment, the interferometer comprises a first optical path and a second optical path;
wherein plurality of passive elements comprises a first coupler, a second coupler, and a delay line;
wherein the first coupler couples an input of the interferometer to the input of the first optical path and to the input of the second optical path,
wherein the second coupler couples the output of the first optical path and the output of the second optical path; and
wherein the delay line is provided the first optical path or is provided in the second optical path.

In one embodiment, the phase modulator is provided at an output of the second coupler.

In an alternative embodiment, the phase modulator is provided in the first optical path. Optionally, the interferometer further comprises an additional phase modulator provided on the second section, wherein the additional phase modulator is provided in the second optical path.

In one embodiment, the photonic assembly further comprises a light source,
wherein the output of the light source is coupled to the input of the interferometer, and
wherein the light source is provided on the second section, or wherein the light source is provided on a third section.

In one alternative embodiment, the phase modulator is provided at an input of the first coupler.

In one embodiment, the photonic assembly further comprises at least one photo-detector,
wherein the at least one photodetector is coupled to the output of the interferometer, and
wherein the at least one photo detector is provided on the second section, or wherein the at least one photo detector is provided on a third section.

In one embodiment, the interferometer comprises a first optical path and a second optical path;
wherein plurality of passive elements comprises a first coupler and a second coupler;
wherein the first coupler couples an input of the interferometer to the input of the first optical path and to the input of the second optical path,
wherein the second coupler couples the output of the first optical path and the output of the second optical path, and
wherein the phase modulator is provided in the first optical path.

In one embodiment, the second coupler is a polarization splitter/combiner, wherein the interferometer further comprises a polarization rotator, and wherein the polarization rotator is provided in the first optical path or the second optical path.

In one embodiment, the plurality of passive photonic elements comprises a first light reflector in the first optical path and a second light reflector in the second optical path.

In one embodiment, the photonic assembly further comprises at least one additional phase modulator provided on the second section and provided at the output of the first phase modulator, the at least one additional phase modulator comprising an electro-optic phase modulator or a Mach-Zehnder modulator.

In one embodiment, the interferometer comprises an optical path, wherein plurality of passive photonic elements comprises a coupler, wherein the coupler couples an input of the interferometer to a first end of the optical path and to a second end of the optical path, and wherein the phase modulator is provided in the optical path.

In one embodiment, the first substrate is a substrate of passive material, and the second substrate is a substrate of active material. Optionally, the passive material is optically passive for light having a wavelength between 1300 nm and 1700 nm, and the active material is optically active for light having a wavelength between 1300 nm and 1700 nm.

In one embodiment the first substrate is of a material comprising silicon or nitrogen.

In one embodiment, the second substrate is of a material comprising a III-V semiconductor material or a II-VI semiconductor material.

In one embodiment, there is provided quantum state encoder comprising a photonic assembly as set out in embodiments above.

In one embodiment, there is provided a quantum state decoder comprising a photonic assembly as set out above.

In one embodiment, there is provided a quantum state encoder as set out above, and a quantum state decoder as set out above.

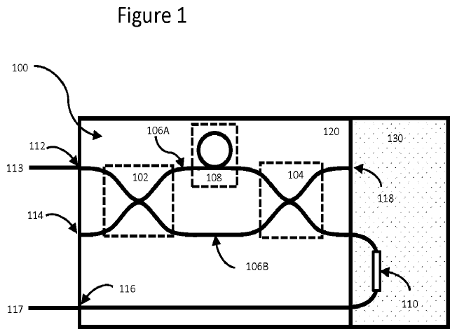

Various embodiments of photonic assemblies are illustrated in each of FIGS. 1-14. In each embodiment, the photonic assembly 100 comprises a first section 120, where the first section 120 comprises a first substrate. The photonic assembly also comprises a second section 130, where the second section 130 comprises a second substrate. Provided on the photonic assembly 100 is an interferometer. The interferometer comprises a plurality of passive photonic elements and a phase modulator. The passive photonic elements are components of the photonic assembly that are transparent or nearly transparent to light propagating within. The number and arrangement of passive photonic elements will vary depending on the type of interferometer, but may comprise one or more waveguides, one or more couplers, and a delay line. The phase modulator is provided on the second section 130 and the plurality of passive photonic elements are provided on the first section 120.

The first sections and second sections described herein each comprise a material substrate upon which photonic circuit elements are provided. Thus, each section can be referred to as a “photonic integrated circuit (PIC)”, or as “a photonic chip” or as an “optical chip”. The first section 120 can be therefore considered a first photonic chip or a first PIC and the second section can be considered a second photonic chip or a second PIC. The photonic assemblies described herein may thus be considered assemblies of photonic chips or assemblies of PICs. Each photonic assembly described herein can therefore be considered a photonic chip assembly, or a photonic integrated circuit assembly, or an optical assembly.

In one embodiment, each section of the photonic chip assembly can be optimised by using a different material for the substrate of each section. Using different substrates for each section allows for separate optimisation of each section according to the photonic elements present on each section. For example, the second section can be provided with a substrate of material with which propagating photons will interact, thus resulting in photon absorption, generation or modulation (such as an active material, as discussed below). The second section is thus optimised for provision of a phase controlling element. The first section may then be provided with a substrate of a material having a higher level of optical transparency than the second material. For example, the first material may have a lower photon absorption coefficient than the second material. The first section is thus optimised for provision of passive photonic elements.

In one embodiment, the first substrate is a substrate of passive material, and the second substrate is a substrate of active material. The first section is thus a passive section and the second section is thus an active section.

An active material may also be referred to as an active photonic material. Active photonic materials are materials that demonstrate opto-electronic effects such that photons propagating in the material interact with the electrons within the material to generate photons, modulate photons or absorb photons. For example, propagating photons can interact with electrons in valence band or the conduction band to stimulate movement between the band gaps to generate, absorb or modulate photons.

A passive material may also be referred to as a passive photonic material. Passive photonic materials are materials with low photon absorption that do not demonstrate opto-electronic effects, or demonstrate reduced electro-optical effects. Photons that propagate in materials demonstrating no electro-optical effects do not interact with the electrons within the material to create excited electronic states that can be used to generate photons, modulate the material refractive index or absorb photons. Passive materials are thus transparent or almost transparent to the photons and the propagating light will therefore maintain its optical characteristics such as phase, amplitude and polarisation. Passive materials are thus generally low propagation loss materials.

The level of photon absorption, and thus the passive or active properties of a material, may depend on the wavelength of the light propagating in the material. For example, a material may have a bandgap between a conduction and valence band that requires photons to have energy close to the value of the bandgap in order to interact with the electrons in the material. Thus, the material may act as an active material for photons exceeding the bandgap energy and as a passive material for photons well below the bandgap energy.

In one embodiment, a first material used for the first substrate and a second material is used for the second substrate such that the first material is passive across a first wavelength range, and the material used for the second substrate is active across the first wavelength range. The photonic assembly may then configured to have an operating range corresponding to the first wavelength range. For example, when the photonic assembly is configured as an encoder, the photonic assembly is configured to generate photons within the first wavelength range, or when the photonic assembly is configured as a decoder, the photonic assembly is configured to receive photons within the first wavelength range. For example, the first wavelength range corresponds to a wavelength range used for telecoms communications. In this example, the wavelength range is between 1300 nm and 1700 nm. Thus, the first material is passive for light having a wavelength between 1300 nm and 1700 nm and the second material is active for light having a wavelength between 1300 nm and 1700 nm. In one example, the photons have a wavelength of 1550 nm.

Different elements provide different band gaps. The gap may also be tuned by varying the concentration of each element within the substrate. Thus, elements and element concentrations may be selected for use in the first substrate or second substrate depending on whether passive or active properties are desired for a certain wavelength. For example, Gallium Arsenide (GaAs) has a gap of around 1.5 eV, corresponding to a wavelength of 820 nm, whereas Silicon has a bandgap of around 1.1 eV (1100 nm), Indium Gallium Arsenide (InGaAs) has a bandgap of around 0.75 eV (1500 nm) and Gallium Nitride (GaN) has a band gap of around 3.4 eV (360 nm).

In one embodiment, the first material comprises silicon or nitrogen. Silicon is an indirect band-gap material and light at wavelengths used in telecommunications (between approx. 1300 nm and approx. 1700 nm, and in one example the wavelength is about 1550 nm) will not interact with electrons in the valence band or conduction band in a single photon process. Some small losses may still be present due to two-photon absorption effects, but light at telecoms wavelengths will propagate through silicon material with reduced material interaction with the material (e.g. with reduced absorption). Other silicon-based materials may also be used as a passive photonic material at telecoms wavelengths, including Silicon Nitride (Si₃N₄). Silicon Nitride has a wider bandgap than Silicon, so two-photon effects are reduced, leading to lower losses in propagating photons. Alternatively, other wide bandgap materials such as diamond may be used as a passive photonic material. So long as the bandgap is larger than the energy of the photons propagating in the material, then the single-photon processes will not excite electrons between the bands and will therefore propagate within the material in a low loss manner. Thus, a material that has a very wide bandgap may be selected such that the material is a passive material for a correspondingly wide range of photon wavelengths.

Due to the passive optical properties of passive materials, in embodiments described herein, passive photonic elements of the interferometer may be formed on a substrate formed of a passive material. The propagation losses of light passing through the passive photonic elements can thus be minimised in these embodiments.

Active optical elements, such as phase modulators, may be formed of optoelectronically active materials. Active materials may demonstrate electro-optic effects, in which an electric field applied to the material will modify the refractive index of the material. Modifications of the refractive index can arise from various effects including but not limited to:
modification of the refractive index via the linear opto-electronic effect (also known as Pockels effect) in which the refractive index depends linearly on an applied electric field.
modifications of the refractive index via the quantum confined Stark effect (QCSE) in which the bandgap of a material is modified via application of an electric field

Active materials can provide very fast response times upon application of the electric field, meaning that a phase modulator formed of active materials is able to switch between modulation states in a fast manner and allow for fast optical switching at picosecond timescales. Such a phase modulator can be referred to as a fast phase modulator. Modulation state switching can be achieved at frequencies at and above GHz frequencies (i.e. frequencies used in QKD schemes). Traveling wave modulators use electrodes along active waveguides designed to propagate electric waves at the same velocity as the optical wave and in this way enhance the electro-optic effect along the propagating waveguide. This allows reaching high modulation speeds.

In one embodiment, the active material is a III-V semiconductor material or a II-VI semiconductor material. Example III-V semiconductor materials comprise Indium-based materials (including Indium Phosphide, or InP), and Gallium based materials (including Gallium Arsenide, or GaAs).

An example embodiment of electro-optic modulation based on Pockels effect is based on a LiNbO₃ waveguide.

It is very difficult to provide a platform comprising layered active and passive photonic materials. Thus, fabricating a phase modulator from active materials on a passive substrate requires complex, expensive and time consuming fabrication techniques. Thus, integrated photonic circuits that utilise a passive photonic substrate, such as silicon, are not as efficient for phase controlling elements from active photonic materials. Furthermore, phase modulation elements that can be formed of passive material on a passive photonic platform provide a low switching rate (as an example, a thermo-optic modulator provides modulation state switching speed on the order of kHz). Such integrated photonic circuits can be unsuitable for use in schemes that require fast reconfiguration of the phase modulator, such as in QKD schemes.

Integrated photonic circuits that utilise an active substrate may be provided with active photonic elements such as phase modulators to provide fast switching speeds. However, when using an active substrate, other photonic elements required of a PIC (such as waveguides, couplers and delay lines), are also formed of active material. Due to the opto-electronic effects present in the active material (e.g. optical gain), such photonic elements would experience loss in photon intensity comparatively greater to that of photonic elements formed of passive materials. Due to this high loss, a PIC formed of exclusively active material is, for example, unsuitable for use in a receiver in a QKD scheme.

Typical losses experienced on an active platform may be on the order of a few dB per centimetre, whereas typical losses experienced on a passive platform may be on the order of a few dB per metre (i.e. two orders of magnitude less). By minimising the number of photonic elements on the active platform, and maximising the number of photonic elements on the passive platform, the overall loss on the assembled photonic circuit is minimised. The interferometer on the assembled photonic assembly therefore operates with lower propagation loss as compared to an interferometer with all interferometer elements on a section comprising active material. The assembled photonic assembly is also able to perform at higher switching speeds than an interferometer formed with all interferometer elements on a section comprising passive material.

In further embodiments, other forms of phase modulator may be provided on the second section. For example, the phase modulator may be a micro-electromechanical System (MEMS) modulator, which is constructed of photonic circuit elements with moveable parts that can be actuated in response to an applied voltage signal at fast switching speeds. These modulators may be provided on a variety of materials, including passive materials such as silicon-based substrates. However, MEMS requires a more complex fabrication process than passive photonic components such as waveguides. Fabricating the MEMS modulator on one chip, fabricating other circuit components on a separate chip, and then joining the chips together is easier, faster, more efficient and less likely to produce imperfections in either the MEMS modulator or the other circuit components.

Other types of phase modulators include carrier injection modulators (CIMs) or carrier depletion modulators (CDMs). In these modulators, phase is induced by increasing or reducing, respectively, the carriers occupying the region that overlaps with the optical mode. CIMs and CDMs are formed by doping a semiconductor region to create P-N junction within the core of a waveguide, and the number of carriers may be modulated with an external signal. Different materials may be used to realise CIMs and CDMs, including using silicon as a substrate. However, CIMs and CDMs require a more complicated fabrication process than fabrication of other photonic elements such as waveguides. Thus, fabricating the CIM(s) or CDM(s) on one chip, fabricating other circuit components on a separate chip, and then joining the chips together is easier, faster, more efficient and less likely to produce imperfections in either the CIM/CDM modulator(s) or the other circuit components.

Other examples of modulators may include plasmonic modulators in which very strong modulation of the propagation speed of tightly confined light-electron quasi-particles at the interface between a material and a metal (known as surface plasmon polaritons) is achieved by modulating a dieletric material refractive index using an electric field Other examples of modulator may include piezo-electric modulators, in which electrical signals modify the mechanical stress and in turn the refractive index of the material through stress-optical effect.

In the embodiments described herein, a photonic assembly is provided that comprises a first section comprising a first substrate and a second section comprising a second substrate. The first section and second section are heterogeneously integrated to form a single, compact assembly. The phase modulator is provided as part of the second section. The second section may be constructed to be optimised for phase modulation. For example, the second section may be constructed from active material and thus optimised to switch at high speeds, and the section may also be constructed to include a quantum well. The passive photonic elements are provided as part of the first section. The first section may be constructed to be optimised for low loss light propagation (e.g. constructed from passive material and/or constructed to include waveguides with smoothed sidewalls). The same optimisations provided to the phase modulator section may not be necessary for the passive photonic elements (e.g. waveguides and couplers do not require fast switching speeds). Thus, an interferometer provided on the photonic assembly formed of the first and second sections can provide fast switching in phase modulation while minimising propagation loss across the entire assembly.

The photonic assembly can be applied for QKD applications. In a QKD scheme a transmitter (“Alice”) will encode photons in different states of chosen bases of quantum states, where the chosen bases and states are varied at random. Quantum information is typically encoded into pulses having pulse generation at GHz frequencies. Thus, in order to randomly shift the basis between different pulses, the phase modulator need to switch between different phase values at least at the frequency of the QKD pulse frequency (GHz frequencies—e.g. 1 GHz or 2 GHz). QKD schemes may also employ intensity modulation of the pulses to be transmitted over a quantum channel—for example, in the generation of decoy states. Intensity modulation may be implemented through an interferometer utilising a phase modulator. In order to vary the intensity between each pulse, the phase modulator would need to shift between different phase values at least at the frequency of the QKD pulse frequency.

The photonic assemblies described herein provide a platform where high switching speeds can be provided while also minimising propagation losses. The phase modulator is provided on a platform that enables efficient switching at speeds required for QKD encoding and intensity modulation, and the passive components are provided on a platform that minimise propagation losses.

The first section and second section may be connected or attached to each other to form a heterogeneously integrated assembly. For example, the first and second sections may be attached by edge coupling (also called butt coupling), where the edge of the first substrate is attached to the edge of the second substrate through means of a bonding material, such as glue or through metallization. Alternatively, the first substrate and second substrate can be attached vertically with the bonding material, or attached vertically by means of wafer bonding (in which the materials are cleaned thoroughly and then attached through Van de Waals forces).

In the embodiments described herein, the interferometer is disposed across both the first section and the second section, with some photonic components of the interferometer disposed on the first section, and some photonic components disposed on the second section. The photonic elements on the first section are optically coupled to the photonic elements on the second section.

In one embodiment, the plurality of passive photonic components comprises one or more waveguides. The one or more waveguides are formed on the substrate of the first section (and may be formed of passive material). The waveguides are provided as part of the interferometer to couple the other elements of the interferometer together to form a photonic circuit. For example, in an embodiment with a first coupler and a second coupler, a first waveguide may couple a first output of the first coupler with a first input of the second coupler, and a second waveguide may couple a second output of the first coupler with a second input of the second coupler. Waveguides may also couple any input or output ports of the first section to the photonic elements of the interferometer present on the second section.

In another embodiment, the interferometer further comprises one or more additional waveguides. The one or more additional waveguides are provided on the second section. The one or more additional waveguides are provided as part of the interferometer to couple the phase modulator to other components of the interferometer. The one or more additional waveguides may also couple any input or output ports of the second section to photonic elements of the interferometer on the first section. In this embodiment, at least one of the one or more waveguides is coupled to at least one of the one or more additional waveguides. The photonic circuit elements provided on the first substrate are thus coupled to the photonic circuit elements on the second substrate, forming the interferometer across the sections forming the photonic assembly.

The coupling of a waveguide on the first section to a waveguide on the second section may be achieved by aligning the waveguides end-to-end such that the optical modes within the waveguides match. For example, a first waveguide on the first section may have a progressively tapered cross-section to geometrically confine the optical mode to a defined diameter. A corresponding second waveguide on the second section may also be progressively tapered to geometrically confine the optical mode to the same defined diameter. Thus, the optical modes in each waveguide have the same diameter and thus can efficiently couple and allow propagation of light across the sections with minimised photon losses. If different materials are used on different sections, the progressive tapering in the first waveguide may be different to the progressive tapering in the second waveguide to achieve the same optical mode diameter.

Alternatively, a first waveguide of the first section and a second waveguide of the second section are coupled evanescently. In this embodiment, each of the first waveguide and the second waveguide have an evanescent mode region. For example, in the evanescent mode regions the diameter of each of the first waveguide and second waveguide is progressively narrowed to a thin diameter. Thus, an optical mode propagating in the first waveguide in the thinned diameter region is not confined in the waveguide but extends out from the waveguide in an evanescent field. The evanescent field couples to the second waveguide to create a mode in that waveguide that becomes progressively confined inside the second waveguide as the mode propagates away from the thinned, evanescent region to the thicker waveguide region in which the mode becomes fully confined. In this embodiment, the first section and second section are arranged vertically, such that the first waveguide and second waveguide are vertically aligned in the evanescent regions of the waveguides.

In a further alternative, a first waveguide is coupled to a first 45 degree reflector, and a second waveguide is coupled to a second 45 degree reflector opposite the first 45 degree reflector.

Photon reflections at the interface between the first waveguide and the second waveguide can be minimised through the provision of index matching glue at the interface and/or using an anti-reflective coating. The anti-reflective coating may be formed with a thickness of a quarter wavelength of the optical mode such that the mode reflected at the boundary between the first waveguide and antireflective coating will destructively interfere with the mode reflected at the boundary of the second waveguide and antireflective coating. The reflections will therefore minimally interfere with photon modes in the first or second waveguides.

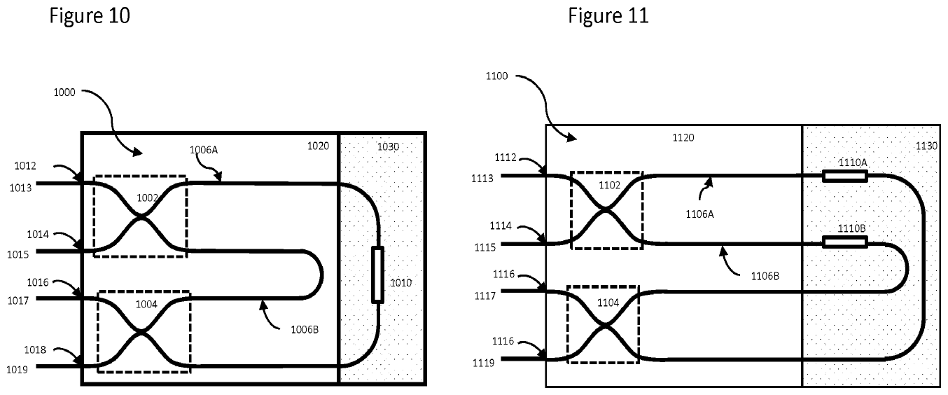

Interferometers described herein may be used as part of QKD applications, including generating encoded states, decoding received encoded states and performing intensity modulation to generate decoy pulses. The embodiments of FIGS. 1-9 and 12-14 are examples of photonic assemblies configured to perform quantum state encoding and/or quantum state decoding. The embodiments of FIGS. 10, 11 and 12 are examples of photonic assemblies providing intensity modulation.

In one embodiment, there is a photonic assembly 100 as shown in FIG. 1. The photonic assembly 100 comprises a delay line interferometer. The delay line interferometer comprises a plurality of passive elements that comprise a first coupler 102, a second coupler 104, and a delay line 108. The interferometer further comprises a first optical path 106A, a second optical path 106B, a first input 112, a second input 114, a first output 116 and second output 118. The first coupler 102 couples the first input 112 and second input 114 of the interferometer to the input of the first optical path 106A and to the input of the second optical path 106B. The second coupler 104 couples the output of the first optical path 106A and the output of the second optical path 106B. The interferometer of photonic assembly 100 further comprises a phase modulator 110. The passive photonic elements are provided on the first section 120, and the phase modulator 110 is provided on the second section 130.

In the illustrated embodiment of FIG. 1, first coupler 102 and second coupler 104 are 2×2 couplers. Thus, the interferometer is shown with two inputs and two outputs. However, it will be understood that the first coupler 102 and/or the second coupler 104 may be 1×2 couplers, such that the interferometer is provided with a single input and/or a single output.

The delay line 108 is provided the first optical path 106A or is provided in the second optical path 106B. As a result, the first optical path 106A and the second optical path 106B have different overall path lengths. Pulses of light traversing the optical path having the delay line will arrive at the second coupler 104 at a later time than the light traversing the optical path without the delay line. When the interferometer is provided with a single light pulse at the input 112, the interferometer will output two time-separated pulses, with a time-separation determined by the overall difference in path length between the first optical path 106A and second optical path 106B. The passive photonic elements may comprise at least one waveguide, wherein the at least one waveguides couple together the interferometer elements. For example, the first optical path 106A and the second optical path 106B may be formed by waveguides provided on the first section.

In the embodiment of FIG. 1, the phase modulator 110 is provided at an output of the second coupler 104. The output of the second coupler 104 may be coupled to the input of the phase modulator using coupled waveguides as described above. The output of the phase modulator 110 may be coupled to the interferometer output 116, or to additional photonic elements of the photonic assembly 100, using coupled waveguides as described above.

The phase modulator 110 thus receives the time-separated pulses that are output by the delay line interferometer of FIG. 1. The phase modulator 110 is configured to be switched between modulation states by an external signal. For example, the phase modulator 110 is a multi-level electro-optic phase modulator responsive to an applied voltage. Light propagating through the phase modulator 110 will be shifted in phase by an amount dependent on the applied voltage. For example, the phase modulator may shift the phase of received light by an amount of

$$0 , \frac{π}{2} , π , \frac{3 π}{2} or - \frac{π}{2} ,$$

or any aroitrary pnase.

The phase modulator 110 is configured to switch between modulation states in time to selectively modulate either pulse of the time-separated pulses. Thus, the time-separated pulse pairs are phase modulated such that a first pulse of a time-separated pulse pair will be shifted in phase by an amount different to the second pulse of a time-separated pulse pair. Thus, quantum information may be encoded by the time-separated pulses output by the interferometer. For example, the early pulse may represent a |0> state and the late pulse representing a |1> state. By varying the phase shift ϕ provided by the phase modulator, the relative phase shift between the output |0> and |1> states may be shifted to encode a chosen arbitrary final state of |ψ_{enc}>=|0>+e^{iϕ}|1>. Encoding states this way may be referred to as “time bin encoding”.

Thus, photonic assembly 100 may form part of a quantum encoder in a quantum communication system, with the phase modulation state chosen based on desired measurement basis.

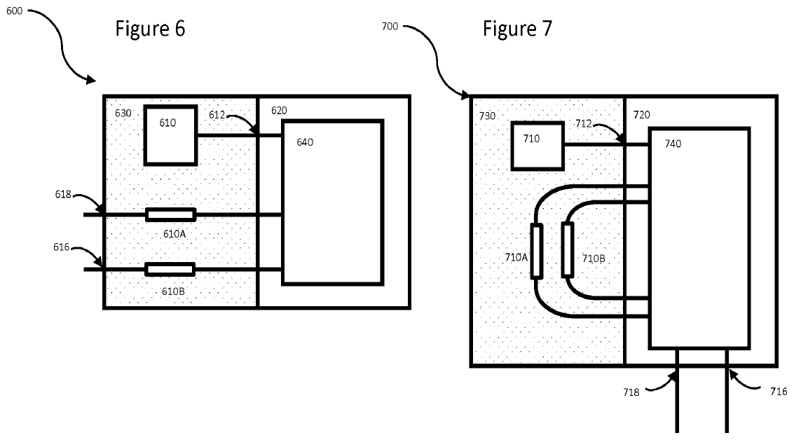

In the illustrated embodiment of FIG. 1, photonic assembly 100 comprises an optical input 113 coupled to first input 112 of the interferometer. The optical input 113 is configured to receive a signal external from the photonic assembly 100. For example, the optical input 113 may receive a light pulse from a light source such as a laser. Photonic assembly 100 further comprises an optical output 117 to provide an output signal external to the photonic assembly 100. For example, the output signal is an encoded state output from the interferometer, and the optical output 117 is coupled to an optical fibre forming a quantum communication channel. The second interferometer output 118 is not coupled to any component and light output from this interferometer output is lost. These illustrated connections are examples only. For example, the photonic assembly 110 may be provided with a second optical input coupled to the second input 114 and may be provided with a second optical output coupled to the second output 118. The optical inputs and optical outputs may not be directly coupled to the inputs and outputs of the interferometer, but instead via other photonic elements on the photonic assembly 100. The photonic assembly may not be provided with an optical input at all, and the input to the interferometer may be coupled to another component of the second section (as described below in connection with FIGS. 6 and 7).

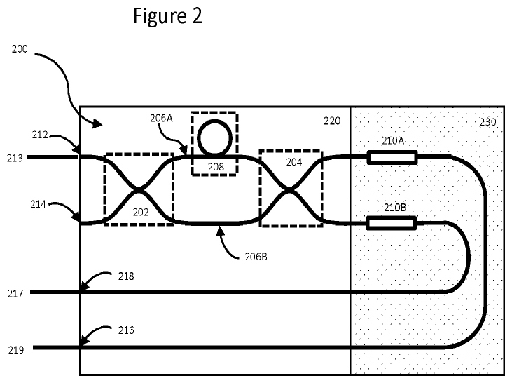

In another embodiment, there is illustrated a photonic assembly 200 as shown in FIG. 2, in which an additional phase modulator is provided. The photonic assembly 200 comprises a delay line interferometer. The delay line interferometer comprises a plurality of passive elements that comprise a first coupler 202, a second coupler 204, and a delay line 208. The interferometer further comprises a first optical path 206A and a second optical path 206B. The delay line interferometer further comprises a first input 212, a second input 214, a first output 216 and a second output 218. The first coupler 202 couples the first input 212 and second input 214 of the interferometer to the input of the first optical path 206A and to the input of the second optical path 206B. The second coupler 204 couples the output of the first optical path 206A and the output of the second optical path 206B. The interferometer of photonic assembly 100 further comprises a first phase modulator 210A and a second phase modulator 210B. The passive photonic elements are provided on the first section 220, and the first and second phase modulators 210A and 210B are provided on the second section 230. The delay line 108 is provided the first optical path 206A or is provided in the second optical path 206B.

In the illustrated embodiment of FIG. 2, first coupler 202 is a 2×2 coupler. Thus, the interferometer is shown with two inputs. However, it will be understood that the first coupler 202 may be a 1×2 coupler, such that the interferometer is provided with a single input.

In the embodiment of FIG. 2, the first phase modulator 210A is provided at a first output of the second coupler 204 and the second phase modulator 210B is provided at a second output of the second coupler 204. The outputs of the second coupler 204 may be coupled to the inputs of the phase modulators using coupled waveguides as described above. The first phase modulator 210A is coupled to the first interferometer output 216 and the second phase modulator 210B is coupled to the second interferometer output 218 using coupled waveguides as described above. Alternatively, the outputs of the phase modulators 210A and 210B may be coupled to additional photonic elements provided on the photonic assembly 200, using coupled waveguides as described above.

The passive photonic elements may comprise at least one waveguide, wherein the at least one waveguides couple together the interferometer elements. For example, the first optical path 206A and the second optical path 206B may be formed by waveguides provided on the first section.

In the illustrated embodiment of FIG. 2, photonic assembly 200 comprises an optical input 213 coupled to first input 212 of the interferometer. The optical input 113 is configured to receive a signal external from the photonic assembly 200. For example, the optical input 213 may receive a light pulse from a light source such as a laser. Photonic assembly 200 further comprises a first optical output 217 and a second optical output 219 to provide output signals external to the photonic assembly 200. For example, the output signals are encoded states output from the interferometer, and the optical outputs 117 and 119 are each coupled to an optical fibre forming a quantum communication channel. These illustrated connections are examples only. The optical inputs and optical outputs may not be directly coupled to the inputs and outputs of the interferometer, but instead via other photonic elements on the photonic assembly 200.

The photonic assembly 200 may not be provided with an optical input at all, and the input to the interferometer may be coupled to another component of the second section (as described below in connection with FIGS. 6 and 7).

The first coupler 202, second coupler 204 and delay line 208 of photonic assembly 200 function as described above for photonic assembly 100 illustrated at FIG. 1, such that when a single pulse of light enters the optical input 212, the second coupler 204 will output a pair of time separated pulses to the first output of the second coupler 204 and a second pair of time separated pulses to the second output of the second coupler 204. Each of the first and second phase modulators are configured to be switched between modulation states by an external signal. Each phase modulator may be switched between different modulation states in time with the received early and/or late pulses so as to encode two different quantum information streams. The phase modulators may be configured to encode in different bases of a QKD scheme. Thus, the photonic assembly can be configured to output two streams of encoded data—a first stream at first optical output 216 and a second stream at optical output 218. The two streams may be used to provide twice the amount of transmitted data, or may be provided for redundancy purposes.

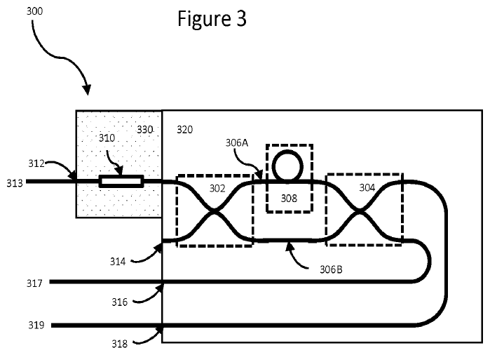

In a further embodiment, there is illustrated a photonic assembly 300 as shown in FIG. 3. The photonic assembly 300 comprises a delay line interferometer. The delay line interferometer comprises a plurality of passive elements that comprise a first coupler 302, a second coupler 304, and a delay line 308. The interferometer further comprises a first optical path 306A and a second optical path 306B. The interferometer further comprises a first input 312, a second input 314, a first output 316 and a second output 318. The first coupler 302 couples the optical input 312 of the photonic assembly 300 to the input of the first optical path 306A and to the input of the second optical path 306B. The second coupler 304 couples the output of the first optical path 306A and the output of the second optical path 306B. The interferometer of photonic assembly 300 further comprises a phase modulator 310. The passive photonic elements are provided on the first section 320, and the phase modulator 310 is provided on the second section 330.

In the illustrated embodiment of FIG. 3, first coupler 302 and second coupler 304 are 2×2 couplers. Thus, the interferometer is shown with two inputs and two outputs. However, it will be understood that the first coupler 302 and/or the second coupler 304 may be 1×2 couplers, such that the interferometer is provided with a single input and/or a single output.

In the embodiment of FIG. 3, the phase modulator 310 is provided at an input of the first coupler 302. The output of the phase modulator 310 may be coupled to the input of the first coupler 302 by means of coupled waveguides as described above. The input of the phase modulator 310 is coupled to an optical input 313 of the optical device assembly 300 (which may be by means of coupled waveguides as described above).

The passive photonic elements may comprise at least one waveguide, wherein the at least one waveguides couple together the interferometer elements. For example, the first optical path 306A and the second optical path 306B may be formed by waveguides provided on the first section.

The phase modulator 310 is configured to be switched between modulation states by an external signal. For example, the phase modulator 310 is a multi-level electro-optic phase modulator responsive to an applied voltage. Light propagating through the phase modulator 310 will be shifted in phase by an amount dependent on the applied voltage. For example, the phase modulator may shift the phase of received light by an amount of

$$0 , \frac{π}{2} , π , \frac{3 π}{2} or - \frac{π}{2} ,$$

or any arbitrary phase.

In one embodiment, the photonic assembly 300 is configured to receive a pair of time-separated pulses at optical input 313 (for example, the time-separated pulses that are output from photonic assembly 100 or 200). The phase modulator 310 is configured to switch between modulation states in time with the time-separated pulse pairs such that a first pulse of a time-separated pulse pair will be shifted in phase by an amount different to the second pulse of a time-separated pulse pair. Thus, the relative phase between each pulse of the pulse pair is shifted based on the chosen modulation state.

The delay line 308 is provided in the first optical path 306A or is provided in the second optical path 306B. As a result, the first optical path 306A and the second optical path 306B have different overall path lengths. Pulses of light traversing the optical path having the delay line will arrive at the second coupler 304 at a later time than the light traversing the optical path without the delay line. After the time-separated pulse pair has passed through the phase modulator 310, both pulses will enter the first coupler 302 and will be passed into each of first optical path 306A and second optical path 306B. The pulses entering the optical path having the delay line (the first optical path 306A in FIG. 3) will be delayed as compared to the pulses entering the optical path without the delay line. In this example embodiment, the pulse pairs entering the photonic assembly 300 have a time separation corresponding to the time difference between pulses entering the first optical path 306A and second optical path 306B. Thus, the early pulse that passes through the first optical path 306A will arrive at the second coupler 304 at the same time as the late pulse entering the second optical path 306B. These pulses will then interfere and the output of the interference will be output from the second coupler into first optical output 316 and second optical output 318. Depending on the modulation state of the phase modulator 310, the pulses will constructively or destructively interfere.

Thus, photonic assembly 300 may thus form part of a quantum decoder in a quantum distribution scheme, with the phase modulation state chosen based on desired measurement basis.

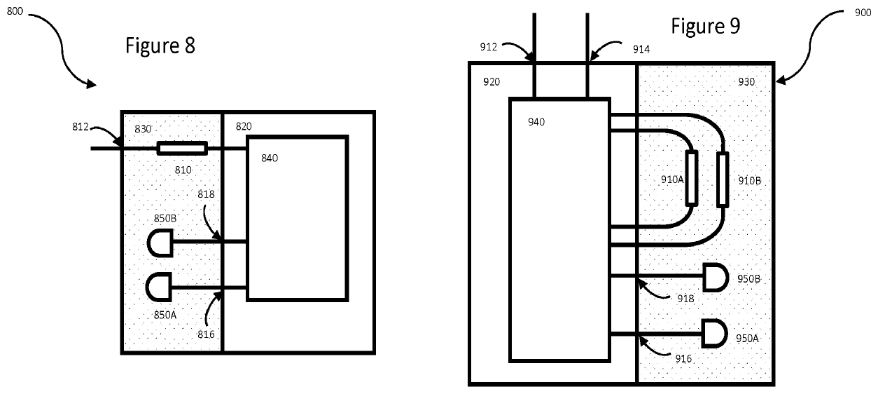

In the illustrated embodiment of FIG. 3, photonic assembly 300 comprises an optical input 313 coupled to first input 312 of the interferometer. The optical input 313 is configured to receive a signal external from the photonic assembly 300. For example, the optical input 313 is coupled to an optical fibre and may receive an encoded state in the form of time-separated light pulses as discussed above. Photonic assembly 100 further comprises a first optical output 317 and second optical output 319 to provide an output signal external to the photonic assembly 300. For example, the output signal is an interference signal of light pulses traversing the first optical path 306A and second optical path 306B. The first optical output 117 and second optical output 119 may be each coupled to a photodetector that measures photon counts and thus indicates a measurement in a chosen basis. These illustrated connections are examples only. For example, the photonic assembly 300 may be provided with a second optical input coupled to the second input 114 and may be provided with only one optical output coupled to the interferometer output. The optical inputs and optical outputs may not be directly coupled to the inputs and outputs of the interferometer, but instead via other photonic elements on the photonic assembly 300. The photonic assembly may not be provided with an optical output at all, and the output of the interferometer may be coupled to another component of the second section (as described below in connection with FIGS. 8 and 9).

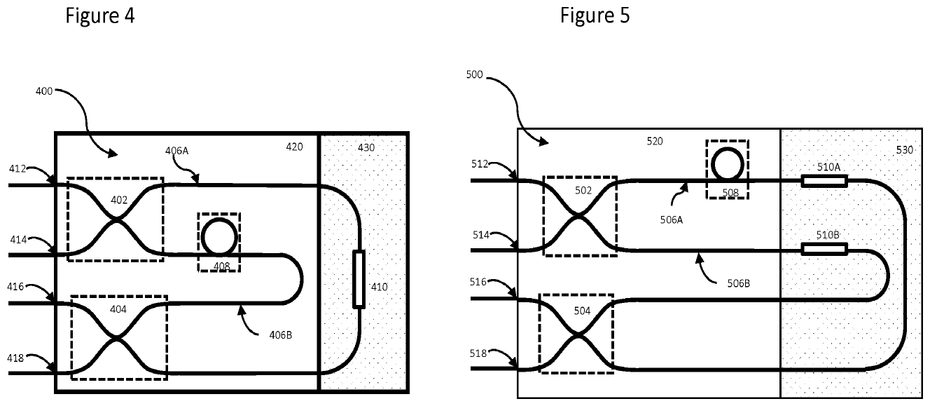

In a further embodiment, there is illustrated a photonic assembly 400 as shown in FIG. 4. The photonic assembly 400 comprises a delay line interferometer. The delay line interferometer comprises a plurality of passive elements that comprise a first coupler 402, a second coupler 404, and a delay line 408. The interferometer further comprises a first optical path 406A, a second optical path 406B, a first input 412, a second input 414, a first output 416 and second output 418. The first coupler 402 couples the first input 412 and second input 414 to the input of the first optical path 406A and to the input of the second optical path 406B. The second coupler 404 couples the output of the first optical path 406A and the output of the second optical path 406B. The interferometer of photonic assembly 400 further comprises a phase modulator 410. The passive photonic elements are provided on the first section 420, and the phase modulator 410 is provided on the second section 430.

The output of the phase modulator 410 may be coupled to the input of the second coupler 404 by means of coupled waveguides as described above. The input of the phase modulator 410 is coupled to the output of the first coupler 402 by means of coupled waveguides as described above.

In the embodiment of FIG. 4, the phase modulator 410 is provided in the first optical path 406A. As a result, any pulse entering the first optical path will be phase shifted by an amount determined by the modulation state of the phase modulator 410. The phase modulator 410 is configured to be switched between modulation states by an external signal. For example, the phase modulator 410 is a multi-level electro-optic phase modulator responsive to an applied voltage. Light propagating through the phase modulator 410 will be shifted in phase by an amount dependent on the applied voltage. For example, the phase modulator may shift the phase of received light by an amount of

$$0 , \frac{π}{2} , π , \frac{3 π}{2} or - \frac{π}{2} ,$$

or any arbitrary phase.

The delay line 408 is provided the first optical path 406A or is provided in the second optical path 406B. As a result, the first optical path 406A and the second optical path 406B have different overall path lengths. Pulses of light traversing the optical path having the delay line will arrive at the second coupler 404 at a later time than the light traversing the optical path without the delay line.

The passive photonic elements may comprise at least one waveguide, wherein the at least one waveguides couple together the interferometer elements. For example, the first optical path 506A and the second optical path 506B may be formed by waveguides provided on the first section.

In a further embodiment, there is illustrated a photonic assembly 500 as shown in FIG. 5. The photonic assembly 500 comprises a delay line interferometer. The delay line interferometer comprises a plurality of passive elements that comprise a first coupler 502, a second coupler 504, and a delay line 508. The interferometer further comprises a first optical path 506A, a second optical path 506B, a first input 512, a second input 514, a first output 516 and second output 518. The first coupler 502 couples the first input 512 and second input 514 to the input of the first optical path 506A and to the input of the second optical path 506B. The second coupler 504 couples the output of the first optical path 506A and the output of the second optical path 506B. In the embodiment of FIG. 5, the photonic assembly 500 comprises a first phase modulator 510A and a second phase modulator 510B. The plurality of passive elements are provided on the first section 520 and the first phase modulator 510A and second phase modulator 510B are provided on the second section 530.

The first phase modulator 510B is provided in the first optical path 506A. The second phase modulator 510B is provided in the second optical path 506B. Any pulse entering the first optical path 506A will be phase shifted by an amount determined by the modulation state of the phase modulator 510A. Any pulse entering the second optical path 506B will be phase shifted by an amount determined by the modulation state of the phase modulator 510B. Each of the first phase modulator 510A and second phase modulator 501B is configured to be switched between modulation states by an external signal, in the same manner as described above for phase modulator 410. The relative phase between a pulse entering the first optical path 506A and the second optical path 506B will be the combination of the phase shift provided by each of the first phase modulator 510A and the second phase modulator 510B.

The outputs of the phase modulators are coupled to the input of the second coupler 504 by means of coupled waveguides as described above. The inputs of the phase modulators are coupled to the output of the first coupler 502 by means of coupled waveguides as described above.

In the illustrated embodiments of FIGS. 4 and 5, first coupler and second coupler are each 2×2 couplers. Thus, each interferometer is shown with two inputs and two outputs. However, it will be understood that the first coupler and/or the second coupler may be 1×2 couplers, such that either interferometer is provided with a single input and/or a single output.

The passive photonic elements may comprise at least one waveguide, wherein the at least one waveguides couple together the interferometer elements. For example, the first optical path 506A and the second optical path 506B may be formed by waveguides provided on the first section.

The interferometer of FIG. 4 and the Interferometer of FIG. 5 can each operate to encode information. In each embodiment, when the interferometer is provided with a single light pulse at an optical input of the photonic assembly, the interferometer will output two time-separated pulses, with a time-separation determined by the overall difference in path length between the first optical path and second optical pat. Due to the presence of the phase modulator in the first optical path (FIG. 4) or phase modulators in the two optical paths (FIG. 5), the time-separated pulses will be shifted in phase relative to one another. Thus, the photonic assembly can be implemented as an encoder, with the encoding basis chosen based on the chosen phase modulation state of the phase modulator.

The interferometer of FIG. 4 and the Interferometer of FIG. 5 can also each operate to decode information. In each embodiment, when the interferometer is provided with a time-separated encoded pulse pair at an optical input of the photonic assembly, the delay line will delay the early pulse propagating through the second optical path such that the pulse will arrive at the same time as the late pulse propagating through the first optical path. These pulses will then interfere at the second coupler and the output of the interference will be output from the second coupler. Depending on the modulation state of the phase modulator or phase modulators, the pulses will constructively or destructively interfere. Thus, each photonic assembly can be implemented as a decoder, with the decoding basis chosen based on the chosen phase modulation state of the phase modulator.

The above described embodiments relate to photonic assemblies where a phase modulator is provided on the second section. A phase modulator is an example of an active photonic component. In further embodiments, additional active components such as light sources or photo detectors may be provided on the second section. The provision of additional active components will be described above in connection with FIGS. 6-9.

In some embodiments, the photonic assembly further comprises a light source. The light source is an active optical component formed from active photonic materials. The light source may be provided on a photonic assembly that is configured to receive input light pulses, such as photonic assembly 100 of FIG. 1, photonic assembly 200 of FIG. 2 or photonic assemblies 400 and 500 of FIGS. 4 and 5. In these embodiments, the output of the light source is coupled to the input of the interferometer. The light source may be provided on the second section, or the light source may be provided on a third section. The third section may be attached to the first section or to the second section. Said third section may be independently optimised in the same manner as the second section described above (for example, the third section may also include a substrate of active material. The active material provides optical gain, which is advantageous as a platform for a light source).

FIG. 6 illustrates a photonic assembly 600 in accordance with an embodiment. In this embodiment, the photonic assembly 600 comprises a first section 620 and second section 630 attached to one another. The photonic assembly 600 further comprises a light source 610, a plurality of passive photonic elements 640, a first phase modulator 610A and a second phase modulator 610B. The passive photonic elements 640 are provided on the first section 620, and the light source 610 and first and second phase modulators 610A and 610B are provided on the second section 730. The passive photonic elements 640 and phase modulators 610A and 610B form an interferometer as described above in connection with FIG. 2. In FIG. 6, the interferometer outputs 616 and 616 are coupled to optical outputs of the photonic assembly 600. The interferometer input 612 is coupled to the light source 610.

In an alternative embodiment, photonic assembly 600 comprises only a single phase modulator 610A. In this embodiment, the arrangement of passive photonic elements 640 phase modulator 610A is as described above in connection with FIG. 1.

FIG. 7 illustrates a photonic assembly 700 in accordance with an embodiment. In this embodiment, the photonic assembly 700 comprises a first section 720 and second section 730 attached to one another. The photonic assembly 700 further comprises a light source 710, a plurality of passive photonic elements 740, a first phase modulator 710A and a second phase modulator 710B. The passive photonic elements 740 are provided on the first section 720, and the light source 710 and first and second phase modulators 710A and 710B are provided on the second section 730. The passive photonic elements 740 and phase modulators 710A and 710B form an interferometer as described above in connection with FIG. 5. In FIG. 7, the interferometer outputs 716 and 716 are coupled to optical outputs of the photonic assembly 700. The interferometer input 712 is coupled to the light source 710.

In an alternative embodiment, photonic assembly 700 comprises only a single phase modulator 710A. In this embodiment, the arrangement of passive photonic elements 740 phase modulator 710A is as described above in connection with FIG. 4.

The above embodiments described in connection with FIGS. 6 and 7 relate to a photonic assembly with a light source and phase modulator(s) provided on the same section. In alternative embodiments, the photonic assembly comprise a third section. Said third section may be independently optimised in the same manner as the second section described above (for example, the third section may also include a substrate of active material). In these alternative embodiments the light source is provided on a different section to the phase modulator(s). Providing all active components on a single section lowers fabrication costs and furthermore provides a more compact photonic assembly.

In the above-described embodiments, the light source is configured to produce light pulses to be received by the interferometer. In one embodiment, the light source includes a laser. Such a laser may be a gain switched laser configured to produce a series of time-separated pulses with randomized phases between the pulses.

In an alternative embodiment, the light source comprises a second laser and an optical filter. The second laser operates as a “master laser” (when using conventional terminology), and the first laser is a “slave laser” (when using conventional terminology).

The second laser provides a seed to the first laser, meaning that laser pulses output by the first laser have a fixed phase relation.

In one embodiment, the second laser is moderated by a phase controlling element. The seed provided by the second laser is modulated by multi-level signals to introduce a varying phase relation between each the maser laser seed, which will in turn produce varying phase between output pulses of the first laser. This phase modulation may be fixed or random.

As another alternative, the laser may provide be a continuous wave CW laser employed alongside an intensity modulator, where the output of the CW laser is selectively modulated to produce a pulsed laser output.

In one embodiment, the light source is configured to produce light pulses with a mean photon number of <1. Alternatively, the optical device is provided with an attenuator coupled to the output of the combiner to attenuate light pulses at the output of the combiner to have a mean photon number of <1. In these embodiments with a mean photon number <1, the system is adapted for quantum communication.

In an alternative embodiment, light pulses are produced with a mean photon number of >1, in which case the system may be adapted for classical communications.

In some embodiments, the photonic assembly further comprises at least one photo-detector. The at least one photo detector is an active optical component formed from active photonic materials. The at least one photodetector may be provided on a photonic assembly that is configured to receive an encoded state for measurement, such as photonic assembly 300 of FIG. 3 or photonic assemblies 400 and 450 of FIGS. 4A and 4B. In these embodiments, the at least one photodetector is coupled to the output of the interferometer. The at least one photo detector may be provided on the second section, or the at least one photo detector may be provided on a third section. The third section may be attached to the first section or to the second section. Said third section may be independently optimised in the same manner as the second section described above (for example, the third section may also include a substrate of active material—an active material provides optical gain and absorption, which is advantageous for use in a photo detector).

FIG. 8 illustrates a photonic assembly 800 in accordance with an embodiment. In this embodiment, the photonic assembly 800 comprises a first section 820 and second section 830 attached to one another. The photonic assembly 800 further comprises a first photodetector 850A, a second photodetector 850B, a plurality of passive photonic elements 640 and a phase modulator 810. The passive photonic elements 840 are provided on the first section 820, and the first and second photodetectors 850A and 850B and the phase modulator 810 are provided on the second section 830. The passive photonic elements 840 and phase modulator 810 form an interferometer as described above in connection with FIG. 3. In FIG. 8, the interferometer outputs 816 and 818 are coupled to the inputs of the first photo detector 850A and second photodetector 850B respectively. The interferometer input 812 is coupled to an optical input of the photonic assembly 800.

FIG. 9 illustrates a photonic assembly 900 in accordance with an embodiment. In this embodiment, the photonic assembly 900 comprises a first section 920 and second section 930 attached to one another. The photonic assembly 900 further comprises a first photodetector 950A, a second photodetector 950B, a plurality of passive photonic elements 940, a first phase modulator 910A and a second phase modulator 910B. The passive photonic elements 940 are provided on the first section 920, and the first and second photodetectors 950A and 950B and first and second phase modulators 910A and 910B are provided on the second section 930. The passive photonic elements 940 and phase modulators 910A and 910B form an interferometer as described above in connection with FIG. 5. In FIG. 9, the interferometer outputs 916 and 918 are coupled to the inputs of the first photo detector 950A and second photodetector 950B respectively. The interferometer inputs 912 and 914 is coupled to optical inputs of the photonic assembly 900.

In an alternative embodiment, photonic assembly 900 comprises only a single phase modulator 910A. In this embodiment, the arrangement of passive photonic elements 940 phase modulator 910A is as described above in connection with FIG. 4.

The above embodiments described in connection with FIGS. 8 and 9 relate to a photonic assembly with at least one photodetector and phase modulator(s) provided on the same section. In alternative embodiments, the photonic assembly comprises a third section. In these alternative embodiments the at least one photodetector is provided on a different section to the phase modulator(s). Said third section may be independently optimised in the same manner as the second section described above (for example, the third section may also include a substrate of active material). Providing all active components on a single section lowers fabrication costs and furthermore provides a more compact photonic assembly.

In one embodiment, there is a photonic assembly 100 as shown in FIG. 10. The photonic assembly 1000 comprises an interferometer. The interferometer comprises a plurality of passive elements that comprise a first coupler 1002 and a second coupler 1004. The interferometer further comprises a first optical path 1006A, a second optical path 1006B, a first input 1012, a second input 1014, a first output 1016 and second output 1018. The first coupler 1002 couples the first input 1012 and second input 1014 of the interferometer to the input of the first optical path and to the input of the second optical path. The second coupler 1014 couples the output of the first optical path 1006A and the output of the second optical path 1006B. The interferometer of photonic assembly 1000 further comprises a phase modulator 1010. The passive photonic elements are provided on the first section 1020, and the phase modulator 1010 is provided on the second section 1030.

In the embodiment of FIG. 10, the phase modulator 1010 is provided in the first optical path 1006A. As a result, any pulse entering the first optical path will be phase shifted by an amount determined by the modulation state of the phase modulator 1010. The phase modulator 1010 is configured to be switched between modulation states by an external signal. For example, the phase modulator 1010 is a multi-level electro-optic phase modulator responsive to an applied voltage. Light propagating through the phase modulator 1010 will be shifted in phase by an amount dependent on the applied voltage. For example, the phase modulator may shift the phase of received light by an amount of

$$0 , \frac{π}{2} , π , \frac{3 π}{2} or - \frac{π}{2} ,$$

or any arbitrary pnase.

In one embodiment, there is a photonic assembly 100 as shown in FIG. 11. The photonic assembly 1000 comprises an interferometer. The interferometer comprises a plurality of passive elements that comprise a first coupler 1102 and a second coupler 1104. The interferometer further comprises a first optical path 1106A, a second optical path 1106B, a first input 1112, a second input 1114, a first output 1116 and second output 1118. The first coupler 1102 couples the first input 1112 and second input 1114 of the interferometer to the input of the first optical path and to the input of the second optical path. The second coupler 1114 couples the output of the first optical path 1106A and the output of the second optical path 1106B. The interferometer of photonic assembly 1100 5 further comprises a phase modulator 1110. The passive photonic elements are provided on the first section 1120, and the phase modulator 1110 is provided on the second section 1130. The interferometer of photonic assembly 1100 further comprises a first phase modulator 1110A and a second phase modulator 1110B. The passive photonic elements are provided on the first section 1120, and the first phase modulator 1110A and second phase modulator 1110B are provided on the second section 1130.

In the embodiment of FIG. 11, the first phase modulator 1110A is provided in the first optical path 1106A and the second phase modulator is provided in the second optical path 1106B. As a result, any pulse entering the first optical path will be phase shifted by an amount determined by the modulation state of the phase first modulator 1110A, and a pulse entering the second optical path will be shifted by an amount determined by the modulation state of the second phase modulator 1110B. Each phase modulator is configured to be switched between modulation states by an external signal. For example, each phase modulator is a multi-level electro-optic phase modulator responsive to an applied voltage. Light propagating through each phase modulator will be shifted in phase by an amount dependent on the applied voltage. For example, each phase modulator may shift the phase of received light by an amount of

$$0 , \frac{π}{2} , π , \frac{3 π}{2} or π ,$$

or any arbitrary phase.

In the illustrated embodiments of FIGS. 10 and 11, first coupler and second coupler are each 2×2 couplers. Thus, each interferometer is shown with two inputs and two outputs. However, it will be understood that the first coupler and/or the second coupler may be 1×2 couplers, such that either interferometer is provided with a single input and/or a single output.

The interferometer of FIG. 10 and the interferometer of FIG. 11 each operate as an intensity modulator. In each case, when the interferometer is provided with a single light pulse at an optical input of the photonic assembly, the first coupler will split the signal into two pulses, with each pulse propagating down the first optical path or the second optical path. Due to the presence of the phase modulator (FIG. 10) or phase modulators (FIG. 11), the pulses propagating through the two optical paths will be phase shifted relative to one another dependent on the modulation state of the phase modulator(s). The pulses will then recombine at the second coupler. The two pulses will then undergo interference at the second coupler leading to a modulation in the intensity of the light output from the second coupler.

In the embodiments of FIGS. 10 and 11, each coupler may be an asymmetric coupler, such that the two outputs of each coupler will differ in intensity. Thus, the light pulse propagating through the two optical paths may have different intensities. The asymmetric couplers may be fixed or tuneable.

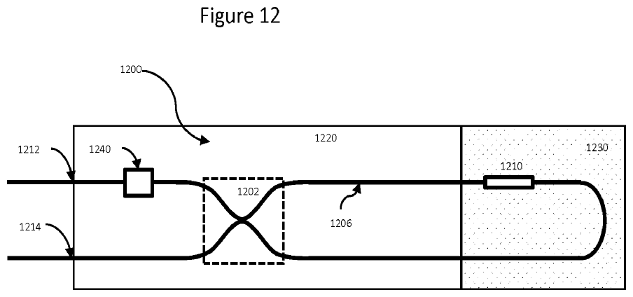

In one embodiment, there is provided a photonic assembly 1200 as illustrated in FIG. 12. The photonic assembly 1200 comprises a Sagnac interferometer. The Sagnac interferometer comprises an optical path 1206, an input 1212 and an output 1214. The Sagnac interferometer comprises a coupler 1202 that is a passive photonic element provided on the first section 1220. The coupler 1202 is a 2×2 coupler that couples an input of the interferometer to a first end of the optical path 1206 and to a second end of the optical path 1206. The Sagnac interferometer further comprises a phase modulator 1210 that is provided on the second section 1230.

The output and input of the phase modulator 1210 are coupled to the coupler 1202 by means of coupled waveguides as described above.

When a light pulse is received at an input of the coupler 1202, the coupler 1202 will output a pulse at each output of the coupler 1202. Thus, a first pulse will propagate clockwise around the optical path 1206 and a second pulse will propagate counter-clockwise around the optical path 1206. The phase modulator 1210 is provided in the optical path 1206, and is provided closer to one output of the coupler 1202 than a second output of the coupler 1202. Thus, a pulse travelling in one direction around the optical path 1206 will arrive at the phase modulator at a different time to the pulse travelling in the opposite direction around the optical path 1206.

The phase modulator 1210 is configured to be switched between modulation states by an external signal. For example, the phase modulator 1210 is a multi-level electro-optic phase modulator responsive to an applied voltage. The phase modulator 1210 is configured to switch between modulation states so selectively phase shift each of the pulse travelling clockwise and the pulse travelling counter-clockwise. For example, the modulation state of the phase modulator 120 is switched between the times of arrival of the two pulses traversing the optical path 1206. As a result, each of the pulses travelling clockwise and counter-clockwise will be shifted in phase by a different amount. Thus, when the pulses combine at coupler 1202 the pulses will interfere. The Sagnac interferometer of FIG. 12 may thus operate as an intensity modulator.

The plurality of passive components further comprises an isolator 1240 provided between the interferometer input 1212 and the input to the coupler 202. The isolator permits light to pass from the interferometer input 1212 to the coupler 202, but prevents light from passing in the reverse direction. Thus, when the coupler 202 receives the clockwise and counter-clockwise pulses, the isolator 1240 will suppress the output of the coupler that would otherwise pass back up to the interferometer input 1212.

The Sagnac interferometer of photonic assembly 1200 may be used to encode quantum states. When two time-separated pulses are provided to interferometer input 1212, the coupler 1202 will output a pulse pair at each output of the coupler 1202. Thus, a first pulse pair will propagate clockwise around the optical path 1206 and a second pulse pair will propagate counter-clockwise around the optical path 1206. The phase modulator will first receive, in order, the early pulse travelling clockwise, the late pulse travelling clockwise, the early pulse travelling counter-clockwise and the late pulse travelling counter-clockwise. The phase modulator 1210 may be configured to be switched between modulation states in time to selectively phase shift the late pulse of each pulse pair by the same amount p. When the pulse pairs recombine at coupler 1202 a chosen arbitrary final state of |ψ_{enc}>|0>+e^{iϕ}|1> may be encoded.

In a variation of the embodiments described above, each photonic assembly may incorporate polarization elements as part of the interferometer. For example, each coupler may be a polarization splitter/combiner, the optical paths are configured to be polarization maintaining and the interferometer may comprise one or two polarization rotators. The polarization elements are provided to reduce losses in the photonic assembly.

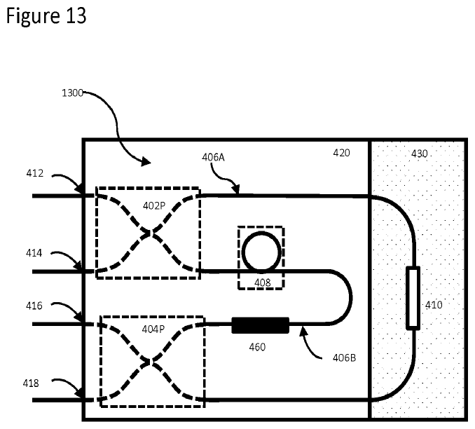

One embodiment is illustrated in FIG. 13. FIG. 13 shows a photonic assembly 1300. The photonic assembly 1300 comprises elements as described above in connection with the embodiment of FIG. 4. The configuration and operation of photonic assembly 1300 is as described above in connection with FIG. 4, so will not be repeated here. In addition to the earlier described components of photonic assembly 400, photonic assembly 1300 comprises a polarization rotator 460 provided in the second optical path 406B. In addition, in this embodiment the first coupler 402P is a polarization splitter/combiner, and the second coupler 402P is a polarization splitter/combiner.

When unpolarised light is received at the first coupler 402P, light output into the first optical path 406A will be polarized in a first polarization state and light output into the second optical path will be polarized into a second polarization state. The second coupler 404P is configured to couple light in the first polarization state into a first output and to couple light in the second polarization state into a second output. The first and second optical paths are polarization maintaining—for example, each optical path may be formed by polarization maintaining waveguides. The light travelling through the first optical path will be received by the polarization rotator 460. The polarization rotator 460 will rotate the polarization from the first polarization state to the second polarization state. Thus, light received at the second coupler from the first optical path 406A and the second optical path will each be in the same polarization state and all light will be coupled into the same output of the coupler 404P. If the photonic assembly 1300 is configured with a single output, using the polarization elements described above means that more light can be output into that single output and thus losses are reduced. As an alternative, only second coupler 404P is a polarization coupler. In this alternative embodiment, the light entering the photonic assembly 1300 at input 412 and/or input 414 is polarized, with a component in the first polarizations state and a component in the second polarization state.

Optionally, there may also be provided a second polarization rotator provided in the first optical path as an alternative to the first polarization rotator or in addition to the first polarization rotator. Each polarization beamsplitter/combiner and each polarization rotator may be a fixed or a tuneable. Since the polarization beamsplitter/combiners and the polarization rotators do not need to be switchable at high speeds, these components may be provided on the first section. In examples alternative to those described above, each polarization beamsplitter/combiner and each polarization rotator may be provided on the second section.

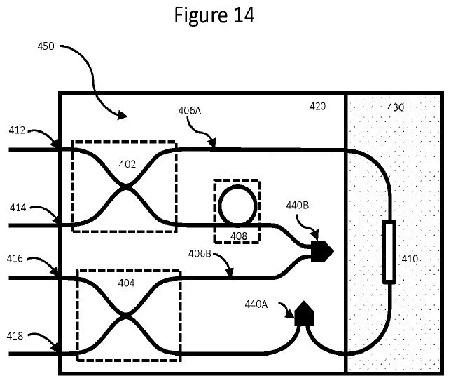

In a variation of the embodiments described above, the plurality of passive photonic elements comprises at least one light reflector. The light reflector can be provided in any part of an optical path and coupled between other passive photonic components. For example, in the embodiments of each of FIGS. 1-5, 10 and 11, the interferometers may be configured as Michelson interferometers, wherein the plurality of passive photonic elements comprises a first light reflector in the first optical path and a second light reflector in the second optical path. One embodiment is illustrated in FIG. 14. FIG. 14 shows a photonic assembly 450. The photonic assembly 450 comprises elements as described above in connection with the embodiment of FIG. 4. The configuration and operation of photonic assembly 450 is as described above in connection with FIG. 4, so will not be repeated here. In addition to the earlier described components of photonic assembly 400, photonic assembly 450 comprises a first reflector 450A provided in the first optical path 406A and a second reflector 450B in the second optical path 450B. Providing reflectors in the interferometer assembly allows for more flexible placement of components and thus more compact integration of photonic elements.

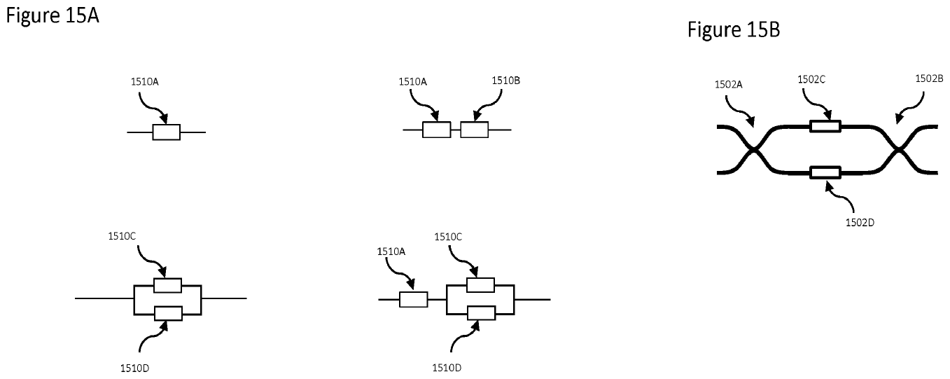

In the above-described embodiments, individual phase modulators are provided as part of the described interferometers. In variations to these embodiments, the interferometers may be implemented with different phase modulator arrangements. For example, there may be provided at least one additional phase modulator. FIG. 15A illustrates different example phase modulator arrangements.

In one example, each phase modulator in the embodiments described above may be a single electro-optical phase modulator 1510A, and are configured to be switched by an external signal between modulation states in the manners described above.

Alternatively, the phase modulator may comprise a first electro-optical phase modulator 1510A and a second phase modulator 1510B provided at the output of the first phase modulator 1510A. Each phase modulator may be independently controlled to switch between modulation states. The provision of two phase modulators allow for a more precise modulation of phase for incoming light.

Alternatively, the phase modulator comprises a Mach-Zehnder modulator, comprising a first phase electro-optical phase modulator 1510C and a second electro-optical phase modulator 1510D.

Alternatively, the phase modulator may comprise a first electro-optical phase modulator 1510A and a Mach-Zehnder Modulator (MZM), comprising a first phase electro-optical phase modulator 1510C and a second electro-optical phase modulator 1510D.

The above phase modulator arrangements are examples only. Further implementations may comprise more than one MZM connected in series, and any number of phase modulators (electro optic phase modulators or the described MZM modulators) connected in series.

In addition, the above described embodiments may further comprise an additional MZM provided at any one of the interferometer inputs and outputs, where the additional MZM is provided on the second section. The additional MZM is configured as an intensity modulator to modulate the intensity of any light pulse entering the interferometer or any light pulse existing the interferometer. Such modulators may be used to attenuate the intensity of light pulses—for example, to reduce the average photon number to <1.

The above phase modulator arrangements comprise passive photonic elements (waveguides and couplers of the Mach-Zehnder modulators) and active photonic elements (the electro-optical modulators). In one embodiment, all photonic elements of the above phase modulator arrangements are provided on the second section. Alternatively, the passive photonic elements are provided on the first section and the active photonic elements are provided on the second section, and the components coupled to one another through waveguide coupling as described above.

The above described embodiments comprise couplers as part of the interferometer. These couplers are illustrated as 2×2 couplers, such as a multi-mode-interferometer (MMI). The 2×2 couplers may be symmetric couplers, in which equal intensity of light is transmitted to each output of the coupler. Alternatively, the couplers may be asymmetric, and provide different output intensities to each output of the coupler. For example, a 2×2 asymmetric coupler may be configured as a Mach Zehnder Interferometer (MZI) as illustrated in FIG. 15B. The MZI comprises a first coupler 1502A, a second coupler 1502B, a first phase modulator 1502C between a first output of the first coupler 1502A and a first input of the second coupler 1502B, and a second phase modulator between a second output of the first coupler 1502A and a second input of the second coupler 1502B. The phase modulators may be configured to impart different phases to tune the intensity output at each of the outputs of the second coupler. The different phases may be fixed or may be tuneable.

The above embodiments provide a photonic assembly with an interferometer having at least one input and at least one output. The at least one input of the interferometer may be coupled to an input or inputs of the photonic assembly to receive signals external to the photonic assembly. Alternatively, the at least one input to the interferometer are coupled to other elements on the photonic assembly, such as a light source, in accordance with embodiments as described above. The at least one output of the interferometer may be coupled to an output or outputs of the photonic assembly. Alternatively, the at least one output of the interferometer may be coupled to other elements on the photonic assembly, such as photo detectors, in accordance with embodiments as described above.

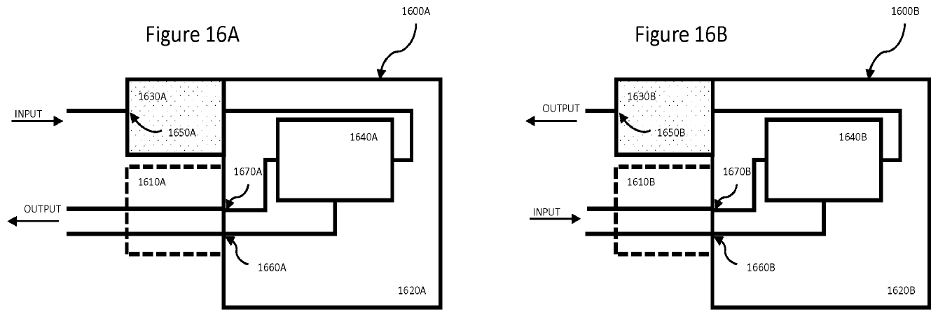

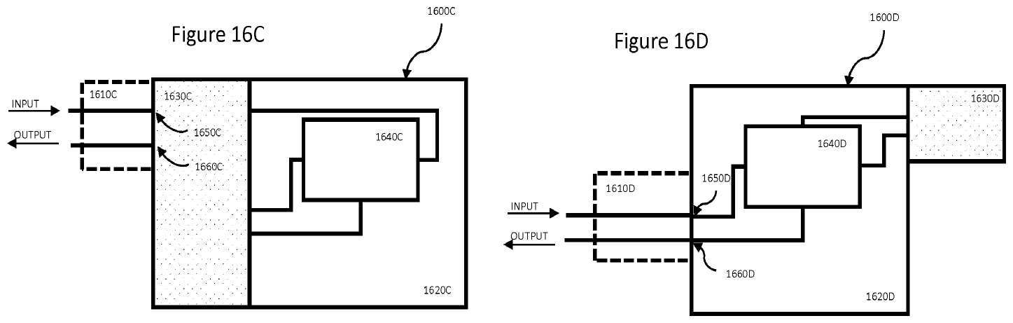

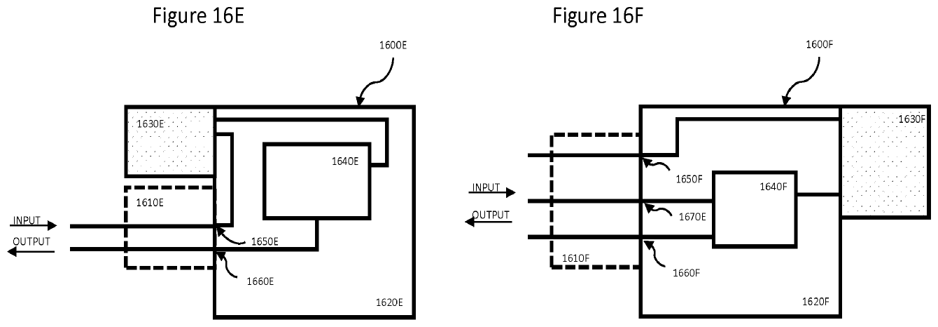

Accordingly, the photonic assembly may be provided with at least one input and/or at least one output. FIGS. 16A-16F illustrate example optical connections to the photonic assembly.

In the embodiment of FIG. 16A, there is provided a photonic assembly 1600A. The photonic assembly 1600A comprises an first section 1620A and a second section 1630A. In accordance with embodiments described above, active photonic elements such as one or more phase modulators are provided on the second section 1630A, and passive photonic elements 1640A are provided on the first section 1620A.

The at least one input to the photonic assembly takes the form of at least one input port on the second section 1630A. The at least one output of the photonic assembly takes the form of at least one output port on the first section 1620A. The single input port 1650A is coupled to a single input fibre and the multiple output ports 1670A and 1660A are coupled to a fibre array 1610A of output fibres. In FIG. 16A, only one input port 1650A is shown, but more than one can be provided and coupled to a fibre array. Similarly, multiple output ports 1670A and 1660A are shown, but more output ports may be provided, or only one output port may be provided and coupled to a single fibre output.

In the embodiment of FIG. 16B, there is provided a photonic assembly 1600B. The photonic assembly 1600B comprises a first section 1620B and a second section 1630B. In accordance with embodiments described above, active photonic elements such as one or more phase modulators are provided on the second section 1630B, and passive photonic elements 1640B are provided on the first section 1620B.

The at least one input to the photonic assembly takes the form of at least one input port on the first section 1620B. The at least one output of the photonic assembly takes the form of at least one output port on the second section 1630B. The multiple input ports 1660B are coupled to a fibre array 1610B, and output port 1630B is coupled to a single output fibre. In FIG. 16B, only one output port 1650B is shown, but more than one can be provided and coupled to a fibre array. Similarly, multiple input ports 1670B and 1660B are shown, but more input ports may be provided, or only one input port may be provided and coupled to a single fibre output.

In the embodiment of FIG. 16C, there is provided a photonic assembly 1600C. The photonic assembly 1600C comprises a first section 1620C and a second section 1630C. In accordance with embodiments described above, active photonic elements such as one or more phase modulators are provided on the second section 1630C, and passive photonic elements 1640B are provided on the first section 1620C.

The at least one input to the photonic assembly takes the form of at least one input port on the second section 1630C. The at least one output of the photonic assembly 1600C takes the form of at least one output port on the second section 1630C. An input port 1650C and an output port 1660C are coupled to a fibre array 1610C comprising an input fibre and an output fibre. In FIG. 16C, only one input port 1650C and only one output port 1660C are shown, but more than one input port and more than one output port can be provided and coupled to the fibre array.

In the embodiment of FIG. 16D, there is provided a photonic assembly 1600D. The photonic assembly 1600D comprises an first section 1620D and a second section 1630D. In accordance with embodiments described above, active photonic elements such as one or more phase modulators are provided on the second section 1630D, and passive photonic elements 1640D are provided on the first section 1620D.

The at least one input to the photonic assembly 1600D takes the form of at least one input port on the first section 1620D. The at least one output of the photonic assembly 1600D takes the form of at least one output port on the first section 1620D. An input port 1650D and an output port 1660D are coupled to a fibre array 1610D comprising an input fibre and an output fibre. In FIG. 16D, only one input port 1650D and only one output port 1660D are shown, but more than one input port and more than one output port can be provided and coupled to the fibre array.

In the embodiment of FIG. 16E, there is provided a photonic assembly 1600E. The photonic assembly 1600E comprises a first section 1620E and a second section 1630E. In accordance with embodiments described above, active photonic elements such as one or more phase modulators are provided on the second section 1630E, and passive photonic elements 1640E are provided on the first section 1620E.

The at least one input to the photonic assembly 1600E takes the form of at least one input port on the first section 1620E. The at least one output of the photonic assembly 1600E takes the form of at least one output port on the first section 1620E. An input port 1650E and an output port 1660E are coupled to a fibre array 1610E comprising an input fibre and an output fibre. In FIG. 16E, only one input port 1650D and only one output port 1660E are shown, but more than one input port and more than one output port can be provided and coupled to the fibre array. The input port 1650E is coupled to the second section 1630E, which is then coupled to the passive photonic elements 1640E. The output port 1660E is coupled to the passive photonic elements 1640E.

In the embodiment of FIG. 16F, there is provided a photonic assembly 1600F. The photonic assembly 1600F comprises a first section 1620F and a second section 1630F. In accordance with embodiments described above, active photonic elements such as one or more phase modulators are provided on the second section 1630F, and passive photonic elements 1640F are provided on the first section 1620F.

The at least one input to the photonic assembly 1600F takes the form of at least one input port on the first section 1620F. The at least one output of the photonic assembly 1600F takes the form of at least one output port on the first section 1620F. Three ports 1650F, 1660F and 1670 F are coupled to a fibre array 1610F comprising three fibres. Each of the three ports 1650F, 1660F and 1670F may function as an input port or an output port. For example, the photonic assembly may have 2 input ports and one output port, or one input port and two output ports depending on the function of the system. In FIG. 16E, three ports are shown, but more input/output ports can be provided and coupled to the fibre array. The port 1650F is coupled to the second section 1630F, which is then coupled to the passive photonic elements 1640F. The remaining ports 1670E and 1670F are coupled to the passive photonic elements 1640E.

As described above, embodiments herein may be implemented as part of a quantum encoder/quantum transmitter or a quantum decoder/quantum receiver. In one embodiment, there is provided a quantum state encoder that comprises the photonic assembly of any one of FIGS. 1-2, 4-7 and 12 that is configured to encode quantum states from incoming light pulses. In one embodiment, the quantum encoder additionally comprises the photonic assembly of any one of FIGS. 10-12 that is configured to provide intensity modulation to light pulses used for quantum encoding. The intensity modulation may be used to generate decoy states, for example. In another embodiment, there is provided a quantum state decoder that comprises the photonic assembly of any one of FIGS. 3-5 and 7-8 configured to decode quantum states.

In a quantum encoder, high propagation losses in the photonic elements may be mitigated by increasing the intensity of light received from the light source. However, propagation losses in the photonic elements at a quantum decoder results in information being lost, particularly in quantum schemes were average photon number of received pulses is <1. The hybrid photonic assemblies described herein for use in a phase decoder mitigates this propagation loss and thus improve the efficiency of the phase decoder and the quantum communication system of which the decoder may form a part.

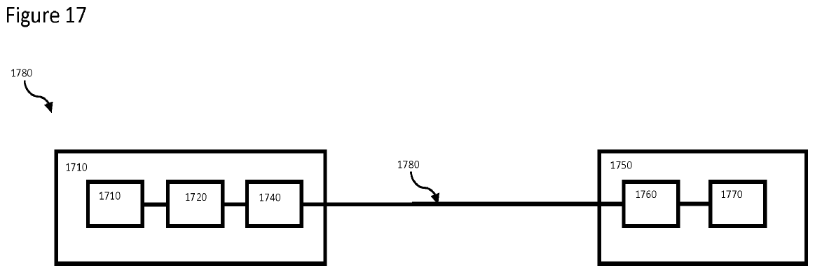

A further embodiment is shown in FIG. 17, in which there is illustrated a quantum communication system 1700 comprising a quantum encoder 1710 in accordance with embodiments as described above, a quantum decoder 1750 in accordance with embodiments as described above and at least one quantum communication channel 1780 connecting the quantum encoder 1710 and quantum decoder 1750. The quantum encoder 1710 may comprise an encoding photonic assembly 1740 comprising a light source (for example, the photonic assembly of FIG. 6 or FIG. 7). Alternatively, the quantum encoder 1710 may comprise an encoder photonic assembly without a light source, but coupled to a light source 1710 implemented separately on the quantum encoder 1710. The quantum encoder may comprise an intensity modulator 1720. The intensity modulator may be implemented on an active photonic assembly as described above. The quantum decoder comprises a decoder photonic assembly 1760 comprising photo-detectors (for example, the photonic assembly of FIG. 8 or FIG. 9). Alternatively, the quantum decoder comprises a decoder photonic assembly without photo detectors, but coupled to at least one photodetector 1770 implemented separately on the quantum decoder 1750.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

Claims:

1. A photonic assembly comprising:
a first section, the first section comprising a first substrate; and
a second section , the second section comprising a second substrate;
wherein the photonic assembly comprises an interferometer, the interferometer comprising a plurality of passive photonic elements and a phase modulator;
wherein the phase modulator is provided on the second section; and
wherein the plurality of passive photonic elements are provided on the first section.

2. The photonic assembly of claim 1, wherein the phase modulator is an electro-optic phase modulator.

3. The photonic assembly of claim 1, wherein the plurality of passive photonic components comprises one or more waveguides and, wherein the interferometer further comprises one or more additional waveguides provided on the second section, wherein at least one of the one or more waveguides is coupled to at least one of the one or more additional waveguides.

4. The photonic assembly of claim 1, wherein the interferometer comprises a first optical path and a second optical path;
wherein the plurality of passive elements comprises a first coupler, a second coupler, and a delay line;
wherein the first coupler couples an input of the interferometer to the input of the first optical path and to the input of the second optical path,
wherein the second coupler couples the output of the first optical path and the output of the second optical path; and
wherein the delay line is provided the first optical path or is provided in the second optical path.

5. The photonic assembly of claim 4, wherein the phase modulator is provided at an output of the second coupler.

6. The photonic assembly of claim 4, wherein the phase modulator is provided in the first optical path wherein, optionally, the interferometer further comprises an additional phase modulator provided on the second section, wherein the additional phase modulator is provided in the second optical path.

7. The photonic assembly of claim 5, further comprising a light source,
wherein the output of the light source is coupled to the input of the interferometer, and
wherein the light source is provided on the second section, or wherein the light source is provided on a third section.

8. The photonic assembly of claim 4, wherein the phase modulator is provided at an input of the first coupler.

9. The photonic assembly of claim 6, further comprising at least one photo-detector,
wherein the at least one photodetector is coupled to the output of the interferometer, and
wherein the at least one photo detector is provided on the second section, or wherein the at least one photo detector is provided on a third section.

10. The photonic assembly of claim 1, wherein the interferometer comprises a first optical path and a second optical path;
wherein plurality of passive elements comprises a first coupler and a second coupler;
wherein the first coupler couples an input of the interferometer to the input of the first optical path and to the input of the second optical path,
wherein the second coupler couples the output of the first optical path and the output of the second optical path, and
wherein the phase modulator is provided in the first optical path.

11. The photonic assembly of claim 4, wherein the second coupler is a polarization splitter/combiner, wherein the interferometer further comprises a polarization rotator, and wherein the polarization rotator is provided in the first optical path or the second optical path.

12. The photonic assembly of claim 4, wherein the plurality of passive photonic elements comprises a first light reflector in the first optical path and a second light reflector in the second optical path.

13. The photonic assembly of claim 1, wherein the interferometer comprises an optical path, wherein plurality of passive photonic elements comprises a coupler, wherein the coupler couples an input of the interferometer to a first end of the optical path and to a second end of the optical path, and wherein the phase modulator is provided in the optical path.

14. The photonic assembly of claim 1, wherein the first substrate is a substrate of passive material, and the second substrate is a substrate of active material.

15. The photonic assembly of claim 14, wherein the passive material is optically passive for light having a wavelength within a first wavelength range, and the active material is optically active for light having a wavelength within the first wavelength range.

16. The photonic assembly of claim 14, wherein the first substrate is of a material comprising silicon or nitrogen.

17. The photonic assembly of claim 14, wherein the second substrate is of a material comprising a 111-V semiconductor material or a II-VI semiconductor material.

18. A quantum state encoder comprising the photonic assembly of claim 5.

19. A quantum state decoder comprising the photonic assembly of claim 8.

20. A quantum communication system comprising a quantum state encoder a quantum state decoder,
wherein the quantum state encoder comprises a first photonic assembly comprising
a first section, the first section comprising a first substrate; and
a second section , the second section comprising a second substrate;
wherein the first photonic assembly comprises a first interferometer, the first interferometer comprising a first plurality of passive photonic elements and a first phase modulator;
wherein the first phase modulator is provided on the second section; and
wherein the first plurality of passive photonic elements are provided on the first section,
wherein the first interferometer comprises a first optical path and a second optical path;
wherein the first plurality of passive elements comprises a first coupler, a second coupler, and a first delay line;
wherein the first coupler couples an input of the first interferometer to the input of the first optical path and to the input of the second optical path,
wherein the second coupler couples the output of the first optical path and the output of the second optical path; and
wherein the first delay line is provided the first optical path or is provided in the second optical path,
wherein the first phase modulator is provided at an output of the second coupler;
and wherein the quantum state decoder comprises a second photonic assembly comprising:
a third section, the third section comprising a third substrate; and
a fourth section , the fourth section comprising a fourth substrate;
wherein the second photonic assembly comprises a second interferometer, the second interferometer comprising a second plurality of passive photonic elements and a second phase modulator;
wherein the second phase modulator is provided on the fourth section; and
wherein the second plurality of passive photonic elements are provided on the third section,
wherein the second interferometer comprises a third optical path and a fourth optical path;
wherein the second plurality of passive elements comprises a third coupler, a fourth coupler, and a second delay line;
wherein the third coupler couples an input of the second interferometer to the input of the third optical path and to the input of the fourth optical path,
wherein the fourth coupler couples the output of the third optical path and the output of the fourth optical path; and
wherein the second delay line is provided the third optical path or is provided in the fourth optical path,
wherein the second phase modulator is provided at an input of the third coupler.
